(19) United States
(12) Patent Application Publication
(10) Pub. No.: US 2015/0192494 A1
(43) Pub. Date: Jul. 9, 2015

(54) SYSTEM AND METHOD FOR CALCULATING STRUCTURAL STRESS

(71) Applicant: Caterpillar Inc., Peoria, IL (US)

(72) Inventors: Samuel John Narber SHOWMAN, Yates City, IL (US); Alexander Heath HAYS, Peoria, IL (US); Timothy William OLMSTED, Aurora, IL (US)

(73) Assignee: Caterpillar Inc., Peoria, IL (US)

(21) Appl. No.: 14/150,924

(22) Filed: Jan. 9, 2014

(51) Int. Cl. G01M 5/00; G06F 17/50

(52) U.S. Cl. CPC G01M 5/0041; G06F 17/5018

(57) ABSTRACT

A system is disclosed for computing structural stress using higher order finite elements. The system may include a weld grouping engine configured to define a group of weld line nodes and a group of weld line elements corresponding to a weld line representing a welded joint, and a spatial search engine configured to detect a plurality of segments between the weld line nodes. The system may also include a structural stress calculation engine configured to retrieve nodal force data of the group of weld line nodes, calculate a sum of nodal forces and a sum of nodal moments for each segment based on the retrieved nodal force data, and calculate a structural stress for each segment based on the sum of nodal forces and the sum of nodal moments calculated for the segment.

### TECHNICAL FIELD

The present disclosure relates generally to a system and method for calculating structural stress analysis and, more particularly, to calculate structural stress of welded joints in a structure.

### BACKGROUND

Machines and equipment include various components that are joined together by welded joints. The welded joints may be subjected to stresses resulting from load applications and residual stresses that pre-exist in the welded joints. Such stresses may cause fatigue cracks, which may propagate within the welded joints, and eventually result in failure of the machines and equipment. Therefore, it is important to analyze the stresses of the welded joints, in order to provide an accurate prediction of the life of the welded joints.

U.S. Pat. No. 7,089,124 (the '124 patent) to Dong et al. is directed to a method for calculating structural stress of a structure. In one embodiment of the '124 patent, the structure is modeled with four-node (quadrilateral) shell or plate elements to generate a shell element model, and finite element analysis is performed on the shell element model to generate nodal force and moment vectors for the elements. Then, selected ones of the nodal force and moment vectors are converted to sectional force vectors (force per unit length) and moment vectors (moment per unit length). Next, a system of linear equations is solved for each element in order to enforce the continuity in neighboring elements. After solving the system of linear equations, the sectional forces and moments are used to calculate the structural stress.

Although the method of the '124 patent may be useful to analyze structural stress of some structures by using linear finite elements, the method of the '124 patent may not be able to accurately analyze the structure stress by using higher order non-linear finite elements. In certain applications, especially when the geometry of the structure is complex, it is desirable to use a finite element model with higher order elements.

The disclosed system and method are directed to solve one or more of the problems set forth above and/or other problems of the prior art.

### SUMMARY

In one aspect, the present disclosure is directed to a system for analyzing structural stress of a structure. The system may include a weld grouping engine configured to define a group of weld line nodes and a group of weld line elements corresponding to a weld line representing a welded joint, and a spatial search engine configured to detect a plurality of segments between the weld line nodes. The system may also include a structural stress calculation engine configured to retrieve nodal force data of the group of weld line nodes, calculate a sum of nodal forces and a sum of nodal moments for each segment based on the retrieved nodal force data, and calculate a structural stress for each segment based on the sum of nodal forces and the sum of nodal moments calculated for the segment.

In another aspect, the present disclosure is directed to a computer-implemented method for analyzing structural stress of a structure. The method may include defining a group of weld line nodes and a group of weld line elements corresponding to a weld line representing a welded joint, and detecting a plurality of segments between the weld line nodes. The method may also include retrieving nodal force data of the group of weld line nodes, calculating a sum of nodal forces and a sum of nodal moments for each segment based on the retrieved nodal force data, and calculating a structural stress for each segment based on the sum of nodal forces and the sum of nodal moments.

In still another aspect, the present disclosure is directed to a non-transitory computer-readable storage device storing instructions for analyzing structural stress of a structure. The instructions may cause one or more computer processing engine to perform operations including defining a group of weld line nodes and a group of weld line elements corresponding to a weld line representing a welded joint, and detecting a plurality of segments between the weld line nodes. The instructions may also cause the one or more computer processing engine to perform operations including retrieving nodal force data of the group of weld line nodes, calculating a sum of nodal forces and a sum of nodal moments for each segment based on the retrieved nodal force data, and calculating a structural stress for each segment based on the sum of nodal forces and the sum of nodal moments.

### BRIEF DESCRIPTION OF THE DRAWINGS

FIG. 1 illustrates an exemplary structural stress analysis system consistent with the disclosed embodiments.

FIG. 2 is a flow chart illustrating an exemplary process of analyzing structural stress of a structure, consistent with disclosed embodiments.

FIG. 3 is a partial perspective view of an exemplary finite element model of a structure, consistent with disclosed embodiments.

FIG. 4 is an enlarged partial perspective view of finite element model with an ordered list of weld line nodes, consistent with disclosed embodiments.

FIG. 5 is an enlarged partial perspective view of finite element model with an element domain consisting of a group of weld line elements, consistent with disclosed embodiments.

FIG. 6 is a perspective view of an element domain with a group of segments, consistent with disclosed embodiments.

FIG. 7 is an enlarged partial perspective view of the element domain of FIG. 6.

### DETAILED DESCRIPTION

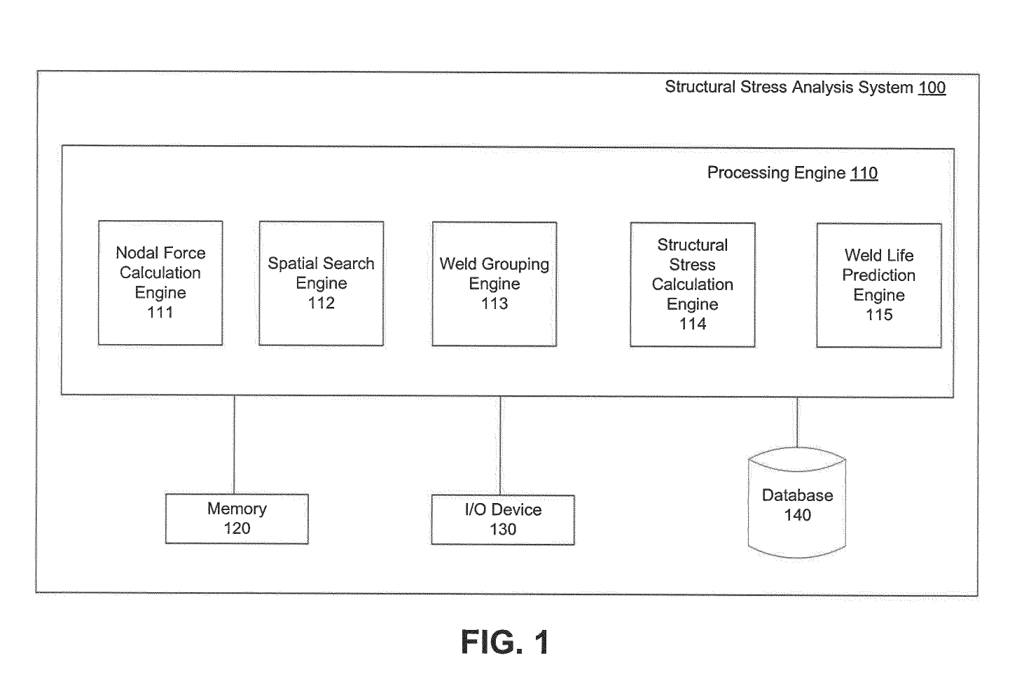

FIG. 1 illustrates an exemplary structural stress analysis system 100 (hereinafter referred to as “system 100”) consistent with the disclosed embodiments. System 100 may include one or more hardware and/or software components configured to display, collect, store, analyze, evaluate, distribute, report, process, record, and/or sort information related to structural stress analysis. As illustrated in FIG. 1, system 100 may include one or more of a processing engine 110, a memory 120, an input/output (I/O) device 130, and a database 140. Although not illustrated in FIG. 1, system 100 may include a network interface to be connected via one or more networks to remote computers or databases.

System 100 may be a server, client, mainframe, desktop, laptop, network computer, workstation, personal digital assistant (PDA), and the like. In one embodiment, system 100 may be a computer configured to receive and process information associated with a structure of a machine, the information including geometric parameters, external load, materials, temperature, and the like.

Processing engine 110 may include one or more processing devices, such as one or more microprocessors from the Pentiumn™ or Xeon™ family manufactured by Intel™, the Turion™ family manufactured by AMD™, or any other type of processors. As illustrated in FIG. 1, processing engine 110 may be communicatively coupled to memory 120, I/O device 130, and database 140. Processing engine 110 may be configured to execute computer program instructions to perform various processes and methods consistent with certain disclosed embodiments. In one exemplary embodiment, the computer program instructions may be loaded into memory 120 for execution by processing engine 110. As illustrated in FIG. 1, processing engine 110 may include a nodal force calculation engine 111, a spatial search engine 112, a weld grouping engine 113, a structural stress calculation engine 114, and a weld life prediction engine 115.

Memory 120 may include a volatile or non-volatile, magnetic, semiconductor, tape, optical, removable, nonremovable, or other type of storage device or computer-readable medium. Memory 120 may be configured to store information and computer program instructions used by system 100 to perform certain functions related to the disclosed embodiments.

I/O device 130 may include one or more components configured to communicate information associated with system 100. For example, I/O device 130 may include a console with an integrated keyboard and mouse to allow a user to input parameters associated with a structure to be analyzed by system 100. I/O device 130 may include one or more displays or other peripheral devices, such as, for example, printers, cameras, microphones, speaker systems, electronic tablets, bar code readers, scanners, or any other suitable type of I/O device 130.

Database 140 may be one or more software and/or hardware components that store, organize, sort, filter, and/or arrange data used by system 100 and/or processing engine 110. Database 140 may store one or more tables, lists, or other data structures containing data associated with structural stress analysis.

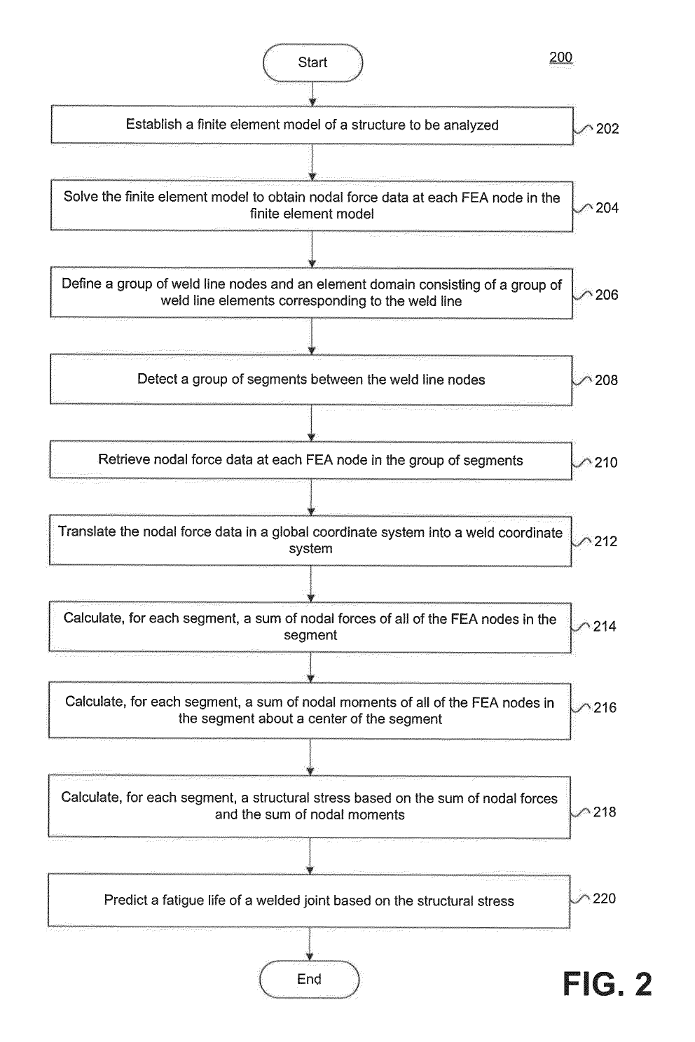

FIG. 2 is a flow chart illustrating an exemplary process 200 of analyzing structural stress of a structure, consistent with disclosed embodiments. Process 200 may begin with calculating nodal force data of the structure by nodal force calculation engine 111. For example, as illustrated in FIG. 2, nodal force calculation engine 111 may first receive structural information of the structure and establish a finite element model of a structure to be analyzed (step 202). The structural information may include geometric parameters, coefficient of thermal expansion, density, Young's modulus, shear modulus, and Poisson's ratio of the structure. Nodal force calculation engine 111 may retrieve the structural information from database 140. Alternatively, a user may input the structural information via I/O device 130.

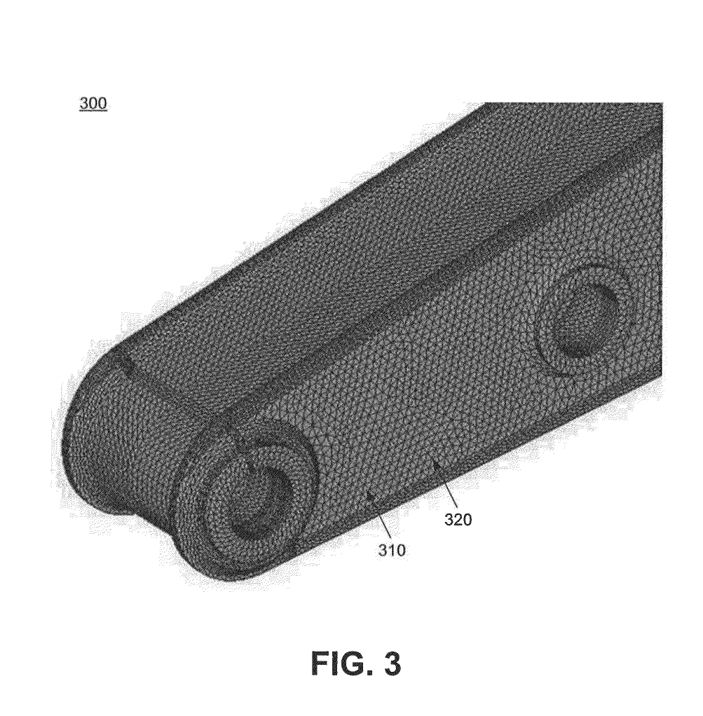

FIG. 3 is a partial perspective view of an exemplary finite element model 300 of a structure, consistent with disclosed embodiments. As illustrated in FIG. 3, finite element model 300 may include a plurality of finite element analysis (FEA) elements 310 interconnected at a plurality of FEA nodes 320. FEA elements 310 may have a tetrahedral shape. Alternatively, in some other embodiments, FEA elements may have other three-dimensional shapes, such as a hexahedral shape, a pyramid shape, and a wedge shape. The FEA elements may have an element shape function of any order, such as linear, parabolic, cubic, etc. In some embodiment, the FEA elements may be higher order finite elements having a higher order element shape function than a linear element shape function. FEA nodes 320 may be located at vertexes of FEA elements 310, along the edges of FEA elements 310, and on the faces of FEA elements 310. The user may specify the shape and size of the FEA elements and the location of the FEA nodes via I/O device 130.

Referring back to FIG. 2, after establishing the finite element model, nodal force calculation engine 111 may solve the finite element model to obtain nodal force data at each FEA node in the finite element model (step 204). The nodal force data may include a force vector in a global coordinate system (x, y, z) at each FEA node. For example, the nodal force data at a node i may be a force vector fᵢ having three (3) components fₓ_{ᵢ}, f_{y}_{ᵢ}, and f_{z}_{ᵢ}. Nodal force calculation engine 111 may store the calculated nodal force data in database 140.

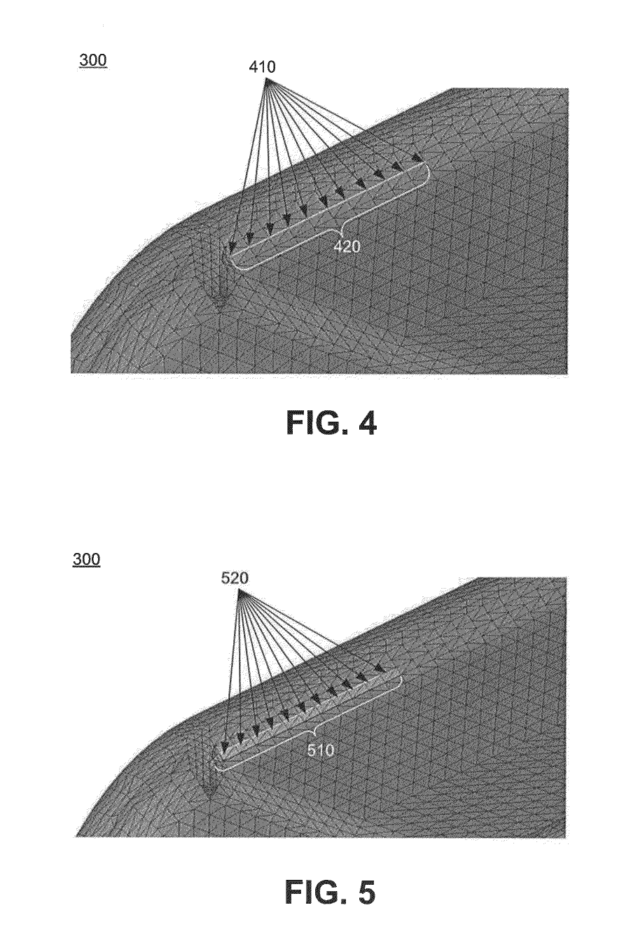

Next, weld grouping engine 113 may define a group of weld line nodes and an element domain consisting of a group of weld line elements corresponding to a weld line in a welded joint to be analyzed (step 206). In some embodiments, weld grouping engine 113 may receive a user input defining the weld line to be analyzed. For example, weld grouping engine 113 may provide a user interface which enables the user to review finite element model 300 from different perspectives, and to manually select, from among the plurality of FEA nodes 320, the group of weld line nodes defining the weld line to be analyzed. FIG. 4 is an enlarged partial perspective view of finite element model 300 with an ordered list of eleven (11) weld line nodes 410 selected by the user that define weld line 420 to be analyzed. The user interface provided by weld grouping engine 113 may also enable the user to manually select, from among the plurality of FEA elements 310, the group of weld line elements corresponding to weld line 420. FIG. 5 is an enlarged partial perspective view of finite element model 300 with element domain 510 consisting of the group of weld line elements 520 selected by the user. Alternatively, weld grouping engine 113 may instruct spatial search engine 112 to search for the group of weld line elements 520. In order to do that, the user may specify automatic spatial search tolerances and the location of a crack propagation plane to be used by spatial search engine 112. Spatial search engine 112 may then search for element domain 510 consisting of the group of weld line elements 520 on one side of the crack propagation plane and along weld line 420 as illustrated in FIG. 4. In some alternative embodiments, the user may specify the location, propagation direction, and depth of a crack, and spatial search engine 112 may determine the location of the crack propagation plane according to a search algorithm.

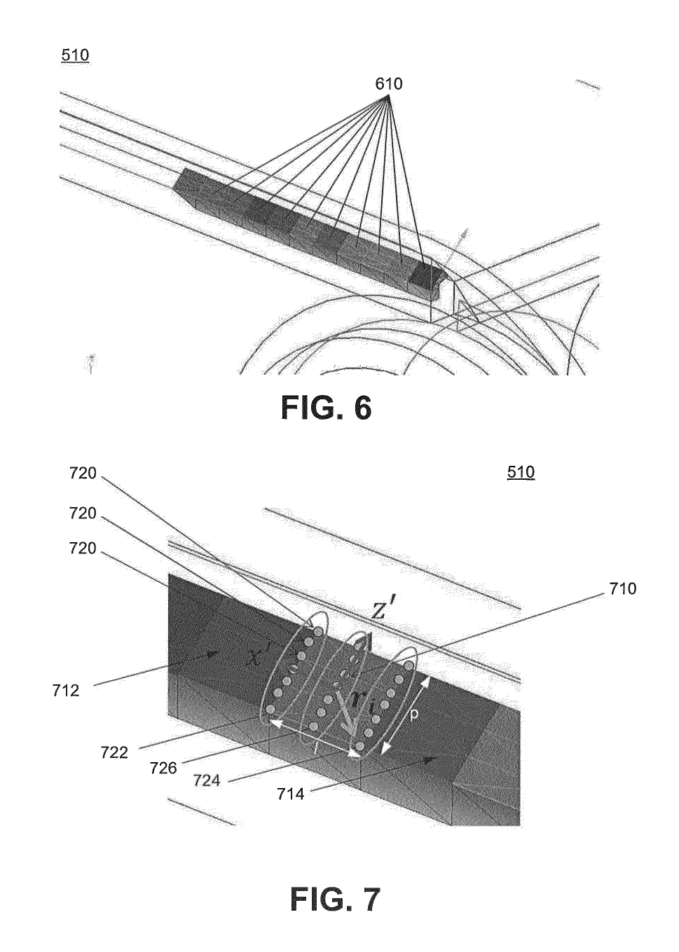

After the weld line nodes and the weld line elements are defined, spatial search engine 112 may detect a group of element faces corresponding to a group of segments between the weld line nodes (step 208). Each segment may include one or more element faces of the weld line elements that correspond to a corresponding segment. FIG. 6 is a perspective view of element domain 510 with the group of segments 610 consistent with disclosed embodiments, from a viewing direction opposite to the one in FIG. 5. Referring to FIG. 6, spatial search engine 112 may first break weld line 420 (as illustrated in FIG. 4) into ten (10) segments between adjacent weld line nodes 410. Then, spatial search engine 112 may detect, for each one of the ten (10) segments 610, a group of six (6) element faces that lie along the crack propagation plane and correspond to the segment 610.

Referring back to FIG. 2, after detecting the group of segments 610, structural stress calculation engine 114 may start a process of calculating the structural stress. Structural stress calculation engine 114 may first retrieve nodal force data at each FEA node in the group of segments 610 (step 210). FIG. 7 is an enlarged partial perspective view of element domain 510 illustrated in FIG. 6. As illustrated in FIG. 7, a segment 710 may include a plurality of FEA nodes 720 positioned at the vertexes and along the edge of the weld line elements that correspond to segment 710. Structural stress calculation engine 114 may retrieve the nodal force data at each of FEA nodes 720 from database 140. As discussed previously, the retrieved nodal force data for the i-th node may be a force vector fᵢ having three (3) components fₓ_{ᵢ}, f_{y}_{ᵢ}, and f_{z}_{ᵢ}.

Structural stress calculation engine 114 may also translate the nodal force data in the global coordinate system (x, y, z) to a weld coordinate system (x′, y′, z′) that is convenient for calculating the structural stress (step 212). As illustrated in FIG. 7, the weld coordinate system (x′, y′, z′) may have an origin at a center of segment 710. As a result, the nodal force data for the i-th node may be translated into a force vector fᵢ′ having three (3) components fₓ_{ᵢ}′, f_{y}_{ᵢ}′, and f_{z}_{ᵢ}′.

Then, structural stress calculation engine 114 may calculate, for each segment, a sum of nodal forces of all of the FEA nodes in the segment (step 214). Structural stress calculation engine 114 may apply a weighting factor to the nodal force of each boundary node while calculating the sum of nodal forces. The weighting factor is determined based on an area of the segment and an area of an adjacent segment that is adjacent to a boundary on which the boundary node is located. For example, as illustrated in FIG. 7, the plurality of FEA nodes 720 in segment 710 may include boundary nodes 722 and 724 that are positioned at left and right boundaries adjoining segment 710 with adjacent segment 712 and 714, respectively. The plurality of FEA nodes 720 may also include a plurality of interior nodes 726 that are not positioned on the left and right boundaries of segment 710. When calculating the sum of nodal forces, structural stress calculation engine 114 may calculate a sum of the nodal forces of all of interior nodes 726, and a weighted sum of the nodal forces of all of boundary nodes 722 and 724. The sum F′ of nodal forces for segment 710 may be represented by:

$${F}^{′} = {\sum }_{i = 1}^{n} {f}_{i}^{′} + {\sum }_{i = 1}^{m} \frac{a}{{A}_{i}} \cdot {f}_{i}^{′}$$

The sum F′ can be decomposed into Fₓ′, F_{y}′, and F_{z}′ respectively represented by,

$${F}_{{x}^{′}} = {\sum }_{i = 1}^{n} {f}_{{x}_{i}^{′}} + {\sum }_{i = 1}^{m} \frac{a}{{A}_{i}} \cdot {f}_{{x}_{i }^{′}}$$

$${F}_{{y}^{′}} = {\sum }_{i = 1}^{n} {f}_{{y}_{i}^{′}} + {\sum }_{i = 1}^{m} \frac{a}{{A}_{i}} \cdot {f}_{{y}_{i}^{′}}$$

$${F}_{{z}^{′}} = {\sum }_{i = 1}^{n} {f}_{{z}_{i}^{′}} + {\sum }_{i = 1}^{m} \frac{a}{{A}_{i}} \cdot {f}_{{z}_{i}^{′}}$$

where fᵢ′ represents the nodal force vector of the i-th node, f_{x′}_{ᵢ}, f_{y′}_{ᵢ}, and f_{z′}_{ᵢ} respectively represent the nodal force values of the i-th node in the x′, y′, and z′ directions, n represents the number of interior nodes 726 in segment 710, m represents the number of boundary nodes 722 and 724 in segment 710, a represents the area of segment 710, Aᵢ represents a sum of the area of segment 710 and the area of the adjacent segment 712 or 714 that is adjacent to the boundary on which the i-th boundary node is located, and a/Aᵢ, represents the weighting factor applied to the nodal force of the i-th boundary node. For example, for an i-th boundary node 722 that is located on the left-side boundary of segment 710, Aᵢ represents a sum of the area of segment 710 and the area of the left-side segment 712. When the area is constant for all of segments 710, 712, and 714, the weighting factors of all of the boundary nodes 722 and 724 may be ½.

Structural stress calculation engine 114 may also calculate, for each segment, a sum of nodal moments of all of the FEA nodes in the segment (step 216). The nodal moment may be calculated about a center of the segment. Similar to the calculation of the sum of nodal forces, structural stress calculation engine 114 may apply a weighting factor to the nodal moment of each boundary node in the segment. For example, the sum M′ of nodal moments for segment 710 may be represented by:

$${M}^{′} = {\sum }_{i = 1}^{n} {r}_{i} \times {f}_{i}^{′} + {\sum }_{i = 1}^{m} {r}_{i} \times ( \frac{a}{{A}_{i}} \cdot {f}_{i}^{′} )$$

where rᵢ represents the position vector of the i-th node relative to the center of segment 710. Similarly, M′ can be decomposed into Mₓ′, M_{y}′, and M_{z}′.

Referring back to FIG. 2, after structural stress calculation engine 114 calculates the sum of nodal forces and the sum of nodal moments for each segment, structural stress calculation engine 114 may calculate the structural stress for each segment based on the sum of nodal forces and the sum of nodal moments (step 218). The structural stress may be a force based reconstruction of a stress state at a specific location that is decomposed into bending, axial, and shear components. Specifically, the structural stress for each segment may have a component Nₘ representing the normal structural stress due to membrane loading, a component N_{b} representing the normal structural stress due to bending loading, a component Nₜ representing the normal structural stress on the plate top, a component N_{bt} representing the normal structural stress on the plate bottom, a component Tₘ representing the shear structural stress due to membrane loading, a component T_{b} representing the shear structural stress due to torsion loading, a component Tₜ representing the shear structural stress on the plate top, a component T_{bt} representing the shear structural stress on the plate bottom, and a component Tₛ representing the shear structural stress due to shear loading. The components for segment 710 may be calculated by:

$${N}_{m} = \frac{{F}_{{y}^{′}}}{pl}$$

$${N}_{b} = \frac{6 {M}_{{x}^{′}}}{{p}^{2} l}$$

$${N}_{t} = {N}_{m} - {N}_{b}$$

$${N}_{bt} = {N}_{m} + {N}_{b}$$

$${T}_{m} = \frac{{F}_{{x}^{′}}}{pl}$$

$${T}_{b} = \frac{6 {M}_{{y}^{′}}}{{p}^{2} l}$$

$${T}_{t} = - {T}_{b} - {T}_{m}$$

$${T}_{bt} = {T}_{b} - {T}_{m}$$

$${T}_{s} = \frac{{F}_{{z}^{′}}}{pl}$$

where p represents the width of segment 710 along the y′ direction illustrated in FIG. 7, and l represents the length of segment 710 along the x′ direction illustrated in FIG. 7.

After calculating the various components of the structural stress for each segment, weld life prediction engine 115 may predict a fatigue life of a welded joint that includes the weld line based on the various components of the structural stress (step 220). Weld life prediction engine 115 may make the prediction based on the various components of the structural stress, and a master stress-fatigue life curve, i.e., the S-N curve. The S-N curve may be predetermined and stored in database 140. Weld life prediction engine 115 may send the results to I/O device 130 to display to the user.

Although in FIG. 7, there are only one column of interior nodes 726 in segment 710, the present disclosure is not so limited. That is, there can be more than one column of interior nodes in segment 710.

In addition, although in the embodiment of the present disclosure the nodal forces are calculated by nodal force calculation engine 111, the present disclosure is not so limited. That is, the nodal forces can be calculated by any other software application or retrieved from any other sources.

### INDUSTRIAL APPLICABILITY

Systems and methods consistent with features related to the disclosed embodiments allow a system to analyze the structural stress of welded joints, and to use the structural stress to predict the fatigue life of the welded joints. The welded joints may exist in any machine or equipment. The disclosed system has potentially wide applications in a broad array of products.

It will be apparent to those skilled in the art that various modifications and variations can be made to the disclosed structural stress analysis system. Other embodiments will be apparent to those skilled in the art from consideration of the specification and practice of the disclosed structural stress analysis system. It is intended that the specification and examples be considered as exemplary only, with a true scope being indicated by the following claims and their equivalents.

What is claimed is:

1. A system for analyzing structural stress of a structure, the system comprising:
a weld grouping engine configured to define a group of weld line nodes and a group of weld line elements corresponding to a weld line representing a welded joint;
a spatial search engine configured to detect a plurality of segments between the weld line nodes; and
a structural stress calculation engine configured to:
retrieve nodal force data of the group of weld line nodes;
calculate a sum of nodal forces and a sum of nodal moments for each segment based on the retrieved nodal force data; and
calculate a structural stress for each segment based on the sum of nodal forces and the sum of nodal moments calculated for the segment.

2. The system of claim 1, further including a nodal force calculation engine configured to calculate the nodal force data based on a finite element model which includes a plurality of FEA elements and a plurality of FEA nodes located at at least the vertexes of the FEA elements.

3. The system of claim 2, wherein the FEA elements have a shape selected from a group of a tetrahedral shape, a hexahedral shape, a pyramid shape, and a wedge shape.

4. The system of claim 2, wherein the FEA elements are higher order finite elements having higher order element shape functions.

54. The system of claim 2, wherein the weld grouping engine is configured to:
receive a user input selecting the group of weld line nodes from among the plurality of FEA nodes of the finite element model; and
receive a user input selecting the group of weld line elements from among the plurality of FEA elements of the finite element model.

6. The system of claim 2, wherein the weld grouping engine is configured to:
receive a user input selecting the group of weld line nodes from among the plurality of FEA nodes of the finite element model;
receive a user input defining automatic spatial search tolerances for searching the group of weld line elements; and
commit a spatial search engine to search for the group of weld line elements from among the plurality of FEA elements based on the automatic spatial search tolerances.

7. The system of claim 1, wherein the plurality of segments lie along a crack propagation plane.

8. The system of claim 1, wherein the structural stress calculation engine is configured to apply a weighting factor to a nodal force and a nodal moment of a boundary node in a segment while calculating the sum of nodal forces and the sum of nodal moments for the segment.

9. The system of claim 8, wherein the weighting factor is determined based on an area of the segment and an area of an adjacent segment that is adjacent to a boundary on with the boundary node is located.

10. The system of claim 1, wherein the structural stress calculation engine is configured to calculate the nodal moments of nodes in a segment about a center of the segment.

11. The system of claim 1, wherein the structural stress calculation engine is configured to translate the nodal force data in a global coordinate system into a weld coordinate system before calculating the sum of nodal forces and the sum of nodal moments.

12. The system of claim 1, wherein the structural stress calculation engine is configured to calculate the structural stress for each segment further based on a total area and a second moment of area of the segment.

13. The system of claim 1, wherein the structural stress includes a bending component, an axial component, and a shear component.

14. The system of claim 1, further including a life prediction engine configured to predict a fatigue life of the welded joint based on the structural stress calculated by the structural stress calculation engine.

15. A computer-implemented method for analyzing structural stress of a structure, the method including:
defining a group of weld line nodes and a group of weld line elements corresponding to a weld line representing a welded joint;
detecting a plurality of segments between the weld line nodes;
retrieving nodal force data of the group of weld line nodes;
calculating a sum of nodal forces and a sum of nodal moments for each segment based on the retrieved nodal force data; and
calculating a structural stress for each segment based on the sum of nodal forces and the sum of nodal moments.

16. The method of claim 15, wherein the nodal force data is calculated based on a finite element model which includes a plurality of FEA elements and a plurality of FEA nodes located at at least the vertexes of the FEA elements.

17. The method of claim 16, wherein the FEA elements have a shape selected from a group of a tetrahedral shape, a hexahedral shape, a pyramid shape, and a wedge shape.

18. The method of claim 15, wherein the plurality of segments lie along a crack propagation plane.

19. The method of claim 15, wherein the calculating the sum of nodal forces and the sum of nodal moments includes applying a weighting factor to a nodal force and a nodal moment of a boundary node in a segment.

20. A non-transitory computer-readable storage device storing instructions for analyzing structural stress of a structure, the instructions causing one or more computer processing engine to perform operations comprising:
defining a group of weld line nodes and a group of weld line elements corresponding to a weld line representing a welded joint;
detecting a plurality of segments between the weld line nodes;
retrieving nodal force data of the group of weld line nodes;
calculating a sum of nodal forces and a sum of nodal moments for each segment based on the retrieved nodal force data; and
calculating a structural stress for each segment based on the sum of nodal forces and the sum of nodal moments.
